(19) United States
(12) Patent Application Publication
(10) Pub. No.: US 2014/0002391 A1
(43) Pub. Date: Jan. 2, 2014

(54) ELECTRONIC DEVICE AND METHOD FOR UNLOCKING ELECTRONIC DEVICE

(71) Applicant: Chi Mei Communication Systems, Inc., New Taipei (TW)

(72) Inventor: KUO-CHUAN LU, New Taipei (TW)

(21) Appl. No.: 13/920,283

(22) Filed: Jun. 18, 2013

(30) Foreign Application Priority Data
Jun. 28, 2012 (TW) 101123159

(51) Int. Cl. G06F 3/041

(52) U.S. Cl. CPC G06F 3/041
USPC 345/173

(57) ABSTRACT

In a method for unlocking an electronic device, the electronic device presents a visual indication as to whether the device is in a locked or an unlocked state. An unlocking icon and a first indication icon are displayed on a display device of the electronic device when the electronic device is locked. In response to detecting a touch signal on the display device, the method determines whether the touch signal is an unlocking signal in relation to the unlocking icon. When the touch signal is the unlocking signal, a touch duration is timed and a second indication icon is displayed on the display device. When the touch duration exceeds a predetermined time, a third indication icon is displayed and the electronic device is unlocked.

### BACKGROUND

1. Technical Field

Embodiments of the present disclosure relate to locking and unlocking technology, and particularly to an electronic device and method for unlocking the electronic device.

2. Description of Related Art

Electronic devices may be locked or unlocked using display devices (e.g., touch panels) of the electronic devices. For portability, electronic devices are becoming smaller. However, when a portable electronic device is inserted into a pocket, function icons of the electronic device may be inadvertently activated. For example, a dialing function of a cell phone may be invoked and a phone call is mistakenly made.

In addition, an electronic device may be unlocked by dragging an icon to a predetermined location. If a user does not drag the icon to the predetermined location, the electronic device cannot be unlocked. This is tedious. Therefore, an improved method for unlocking the electronic device is desired.

### BRIEF DESCRIPTION OF THE DRAWINGS

FIG. 1 is a block diagram of one embodiment of an electronic device including an unlocking system.

FIG. 2 is a first schematic diagram of an unlocking procedure using the unlocking system.

FIG. 3 is a second schematic diagram of the unlocking procedure using the unlocking system.

FIG. 4 is a third schematic diagram of the unlocking procedure using the unlocking system.

FIG. 5 is a schematic diagram of a coordinate range on a coordinate system of the electronic device.

FIG. 6 is a flowchart of one embodiment of a method for unlocking the electronic device using the unlocking system.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

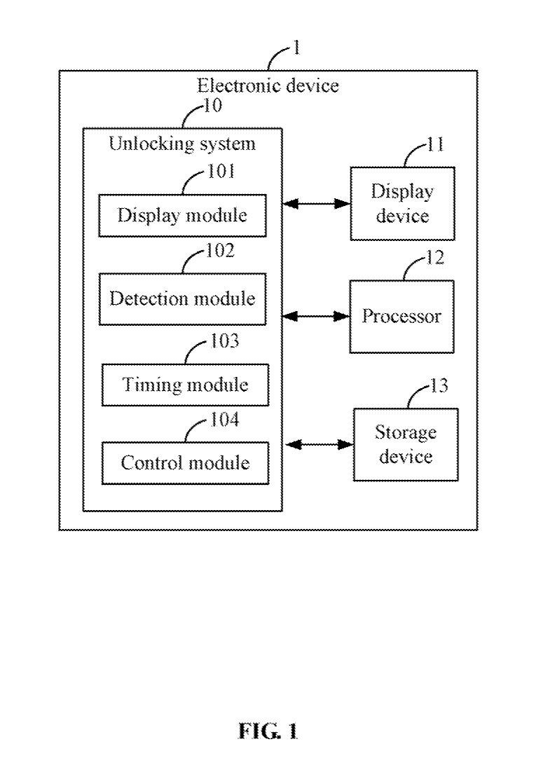

FIG. 1 is a block diagram of one embodiment of an electronic device 1 including an unlocking system 10. The electronic device 1 further includes a display device 11, at least one processor 12, and a storage device 13. FIG. 1 illustrates only one example of the electronic device 1 that may include more or fewer components than illustrated, or have a different configuration of the various components.

In some embodiments, the display device 11 may be a touch panel (e.g., a capacitive touch panel), which supports multi-touch operations. The electronic device 1 may be a mobile phone, a tablet computer, a personal digital assistant, a notebook computer, or similar device.

In some embodiments, the electronic device 1 may be unlocked when a user does not need to operate the electronic device 1, to reduce power consumption. The unlocking system 10 may display an unlocking icon on the display device 11 when the electronic device 1 is locked, display different indication icons to indicate that the electronic device 1 is in different states (e.g., a locked state and an unlocked state), and unlock the electronic device 1 when an unlocking signal for a predetermined duration is received.

In one embodiment, the unlocking system 10 may include computerized instructions in the form of one or more programs that are executed by the at least one processor 12 and stored in the storage device 13. The storage device 13 stores one or more programs, such as operating systems, applications of the electronic device 1, and various kinds of data, such as function icons. In some embodiments, the storage device 13 may be an external storage card, such as a memory stick, a smart media card, a compact flash card, a secure digital card, or any other type of memory storage device.

In one embodiment, the unlocking system 10 may include one or more modules, for example, a display module 101, a detection module 102, a timing module 103, and a control module 104. In general, the word “module,” as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

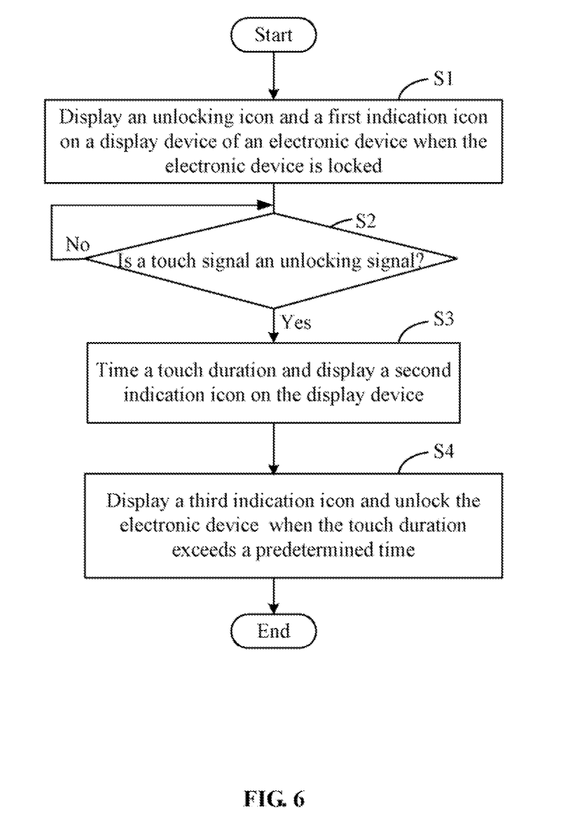

FIG. 6 is a flowchart of one embodiment of a method for unlocking the electronic device 1 using the unlocking system 10. Depending on the embodiment, additional steps may be added, others removed, and the ordering of the steps may be changed.

In step S1, the display module 101 displays an unlocking icon 100 and a first indication icon 201 on the display device 11 when the electronic device 1 is locked. The unlocking icon 100 may be touched by the user to unlock the electronic device 1. In some embodiments, an indication block 200 may be preset by the display module 101 to enclose a plurality of indication icons, which are used to represent different states of the electronic device 1. The plurality of indication icons may be circles, rectangles, or other graphics. In other embodiments, the indication icons may be not enclosed by any block.

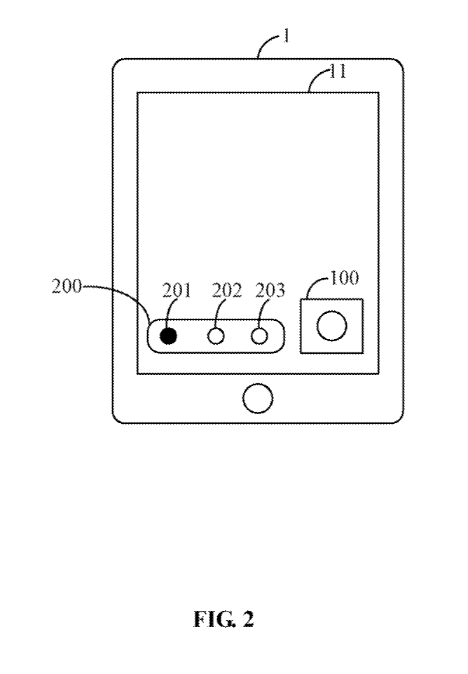

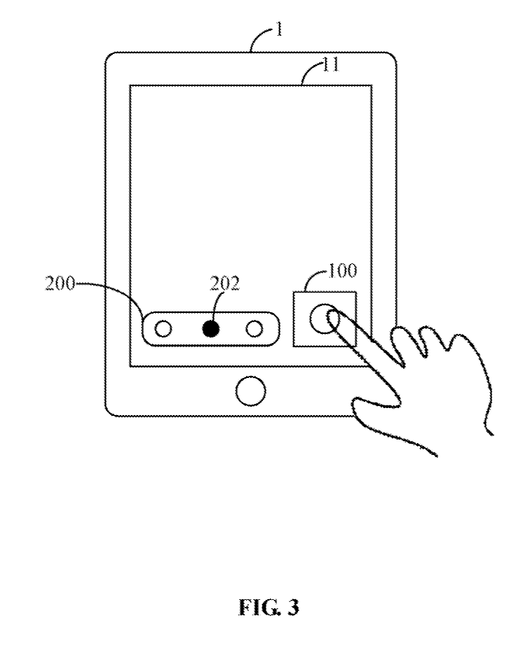

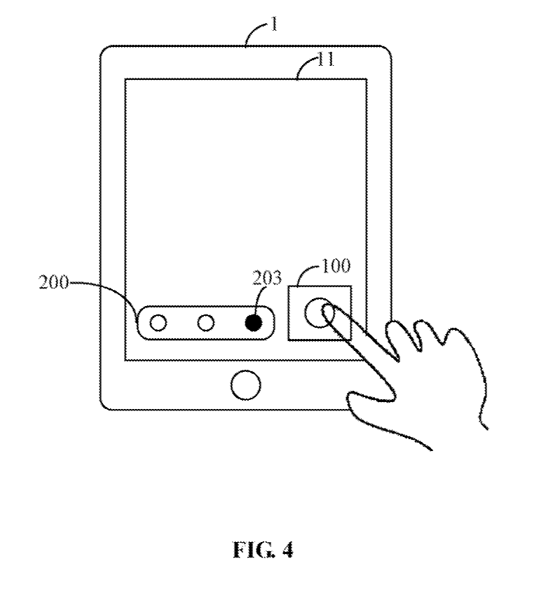

As shown in FIG. 2, the indication block 200 has the first indication icon 201, a second indication icon 202, and a third indication icon 203. The first indication icon 201 represents that the electronic device 1 is in a locked state, and no unlocking signal is received. An unlocking signal is generated by the display module 101 when the unlocking icon 100 has been touched. The second indication icon 202, as shown in FIG. 3, represents that the electronic device 1 is in the locked state, and the unlocking signal is received. The third indication icon 203 represents that the electronic device 1 is in the unlocked state. Furthermore, the third indication icon 203, as shown in FIG. 4, represents that the electronic device 1 is in the unlocked state.

In some embodiments, the plurality of indication icons may show different colors according to changes of the states of the electronic device 1. For example, the first indication icon 201 is displayed with a first color (e.g., red), the second indication icon 202 is displayed with a second color (e.g., yellow), and the third indication icon 203 is displayed with a third color (e.g., green). When one of the plurality of indication icons is highlighted, the other indication icons are not highlighted.

In other embodiments, the indication block 200 may include a virtual lamp for displaying with different colors when the electronic device 1 is in different predetermined states. For example, the virtual lamp may display with the first color when the electronic device 1 is in the locked state and no unlocking signal is received, and display with the second color when electronic device 1 is in the locked state and one unlocking signal is received.

In other embodiments, the plurality of indication icons may use different graphics. When one of the plurality of indication icons is shown, the other indication icons are hidden, that is, the other indication icons are not shown.

The display module 101 may display the unlocking icon 100 at a predetermined position of the display device 11, or at a random position of the display device 11 each time the electronic device 1 is locked.

In step S2, the detection module 102 detects a touch signal on the display device 11, and determines whether the touch signal is an unlocking signal in relation to the unlocking icon 100 on the display device 11. When the touch signal is the unlocking signal in relation to the unlocking icon 100, step S3 is implemented. When the touch signal is not the unlocking signal, step S2 is repeated.

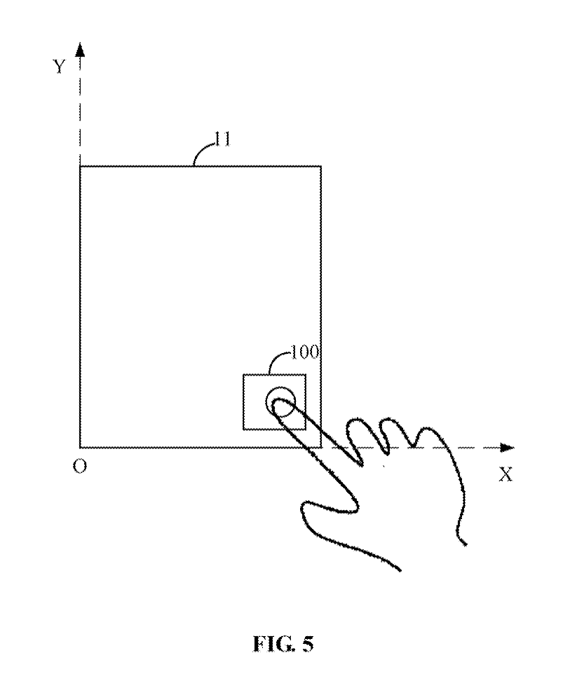

In some embodiments, the detection module 102 determines a coordinate range of the unlocking icon 100 on the display device 11 according to a location of the unlocking icon 100, and determines coordinates of the touch signal. As shown in FIG. 5, a coordinate system is constructed on the display device 11 of the electronic device 1. The coordinate range and the coordinates of the touch signal may be determined based on the predetermined coordinate system. For example, a length of the display device 11 of the electronic device 1 may be represented as a Y axis of the predetermined coordinate system, and a width of the display device 11 of the electronic device may be represented as an X axis of the predetermined coordinate system.

The coordinate range may include an X coordinate range (e.g., [X1, X2]), and a Y coordinate range (e.g., [Y1, Y2]). The coordinates of the touch signal may be (Xₙ, Yₙ). When the coordinates of the touch signal are within the coordinate range of the unlocking icon 100, such as, X1≦X≦X2 and Y1≦Yₙ≦Y2, the detection module 102 determines that the touch signal is the unlocking signal, that is, the unlocking icon 100 has been touched. When the coordinates of the touch signal are not within the coordinate range of the unlocking icon 100, the detection module 102 determines that the touch signal is not the unlocking signal, that is, the unlocking icon 100 has not been touched.

When the touch signal is determined to be the unlocking signal in relation to the unlocking icon 100, in step S3, the timing module 103 times a touch duration, and the display module 101 displays the second indication icon 202 on the display device 11. As mentioned above, the second indication icon 202 represents that the electronic device 1 is in the locked state, and the detection module 102 has detected the unlocking signal.

In step S4 the control module 104 unlocks the electronic device 1 when the touch duration exceeds a predetermined time (e.g., 4 seconds), and the display module 101 displays the third indication icon when the electronic device 1 is in the unlocked state.

According to the plurality of indication icons displayed on the display device 11, the user may view different states of the electronic device 1, and follow an unlocking procedure visually, and may further determine to continue touching the unlocking icon 100 until the electronic device 1 is unlocked, or stop the unlocking procedure by releasing the unlocking icon 100.

It should be emphasized that the above-described embodiments of the present disclosure, particularly, any embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure is protected by the following claims.

What is claimed is:

1. A computer-implemented method for unlocking an electronic device, the electronic device comprising a processor and a display device, the method comprising:
displaying an unlocking icon and a first indication icon on the display device when the electronic device is locked;
in response to detecting a touch signal on the display device, determining whether the touch signal is an unlocking signal in relation to the unlocking icon;
timing a touch duration and displaying a second indication icon on the display device, when the touch signal is the unlocking signal; and
displaying a third indication icon and unlocking the electronic device using the processor, when the touch duration exceeds a predetermined time.

2. The method according to claim 1, wherein the unlocking icon is displayed at a predetermined position of the display device, or displayed at a random position of the display device each time the electronic device is locked.

3. The method according to claim 1, wherein the step of determining whether the touch signal is an unlocking signal in relation to the unlocking icon comprises:
determining a coordinate range of the unlocking icon on the display device, and determining coordinates of the touch signal; and
determining that the touch signal is the unlocking signal when the coordinates of the touch signal are within the coordinate range of the unlocking icon; or
determining that the touch signal is not the unlocking signal when the coordinates of the touch signal are not within the coordinate range of the unlocking icon.

4. The method according to claim 1, wherein the first indication icon is displayed with a first color, the second indication icon is displayed with a second color, and the third indication icon is displayed with a third color.

5. The method according to claim 1, wherein the first indication icon, the second indication icon, and the third indication icon are positioned in an indication block.

6. The method according to claim 5, wherein the indication block has a virtual lamp to replace the first indication icon, the second indication icon, and the third indication icon, the virtual lamp being displayed with different colors when the electronic device is in different predetermined states.

7. An electronic device, comprising:
a display device;
at least one processor; and
a storage device storing a plurality of instructions, which when executed by the processor, causes the at least one processor to:
display an unlocking icon and a first indication icon on the display device when the electronic device is locked;
determine whether a touch signal is an unlocking signal in relation to the unlocking icon, in response to detecting the touch signal on the display device;
time a touch duration when the touch signal is the unlocking signal;
display a second indication icon on the display device when the touch signal is the unlocking signal, and display a third indication icon when the touch duration exceeds a predetermined time; and
unlock the electronic device when the touch duration exceeds the predetermined time.

8. The electronic device according to claim 7, wherein the unlocking icon is displayed at a predetermined position of the display device, or at a random position of the display device each time the electronic device is locked.

9. The electronic device according to claim 7, wherein the at least one processor further:
determine a coordinate range of the unlocking icon on the display device, and determine coordinates of the touch signal; and
determine that the touch signal is the unlocking signal when the coordinates of the touch signal are within the coordinate range of the unlocking icon; or
determine that the touch signal is not the unlocking signal when the coordinates of the touch signal are not within the coordinate range of the unlocking icon.

10. The electronic device according to claim 7, wherein the first indication icon is displayed with a first color, the second indication icon is displayed with a second color, and the third indication icon is displayed with a third color.

11. The electronic device according to claim 7, wherein the first indication icon, the second indication icon, and the third indication icon are positioned in an indication block.

12. The electronic device according to claim 11, wherein the indication block has a virtual lamp to replace the first indication icon, the second indication icon, and the third indication icon, the virtual lamp being displayed with different colors when the electronic device is in different predetermined states.

13. A non-transitory storage medium having stored thereon instructions that, when executed by a processor of an electronic device, causes the electronic device to perform a method for unlock the electronic device, the electronic device comprising a display device, the method comprising:
displaying an unlocking icon and a first indication icon on the display device when the electronic device is locked;
in response to detecting a touch signal on the display device, determining whether the touch signal is an unlocking signal in relation to the unlocking icon;
timing a touch duration and displaying a second indication icon on the display device, when the touch signal is the unlocking signal; and
displaying a third indication icon and unlocking the electronic device using the processor, when the touch duration exceeds a predetermined time.

14. The non-transitory storage medium according to claim 13, wherein the unlocking icon is displayed at a predetermined position of the display device, or displayed at a random position of the display device each time the electronic device is locked.

15. The non-transitory storage medium according to claim 13, wherein the step of determining whether the touch signal is an unlocking signal in relation to the unlocking icon comprises:
determining a coordinate range of the unlocking icon on the display device, and determining coordinates of the touch signal; and
determining that the touch signal is the unlocking signal when the coordinates of the touch signal are within the coordinate range of the unlocking icon; or
determining that the touch signal is not the unlocking signal when the coordinates of the touch signal are not within the coordinate range of the unlocking icon.

16. The non-transitory storage medium according to claim 13, wherein the first indication icon is displayed with a first color, the second indication icon is displayed with a second color, and the third indication icon is displayed with a third color.

17. The non-transitory storage medium according to claim 13, wherein the first indication icon, the second indication icon, and the third indication icon are positioned in an indication block.

18. The non-transitory storage medium according to claim 17, wherein the indication block has a virtual lamp to replace the first indication icon, the second indication icon, and the third indication icon, the virtual lamp being displayed with different colors when the electronic device is in different predetermined states.
